(19) United States
(12) Patent Application Publication
(10) Pub. No.: US 2011/0295778 A1
(43) Pub. Date: Dec. 1, 2011

(54) INFORMATION PROCESSING APPARATUS, INFORMATION PROCESSING METHOD, AND PROGRAM

(75) Inventors: Shunichi HOMMA, Tokyo (JP); Yoshiaki IWAI, Tokyo (JP); Takayuki YOSHIGAHARA, Tokyo (JP)

(73) Assignee: Sony Corporation, Tokyo (JP)

(21) Appl. No.: 13/048,309

(22) Filed: Mar. 15, 2011

(30) Foreign Application Priority Data
May 27, 2010 (JP) 2010-121272

(51) Int. Cl. G06F 15/18

(52) U.S. Cl. 706/12

(57) ABSTRACT

There is provided an information processing apparatus including a data pool generation section which generates an unknown data pool, a learning sample collection section which randomly collects a plurality of learning samples from the unknown data pool, a classifier generation section which generates a plurality of classifiers using the learning samples, an output feature quantity acquisition section which associates with the data, for each piece of the data, a plurality of output values, which are obtained by inputting the data into the plurality of classifiers to identify the data, as an output feature quantity represented in an output feature quantity space different from the feature quantity space, and a classification section which classifies each piece of the data into any one of a predetermined number of the classes based on the output feature quantity.

### BACKGROUND OF THE INVENTION

1. Field of the Invention

The present invention relates to an information processing apparatus, an information processing method, and a program, and particularly to an information processing apparatus, an information processing method, and a program for classifying data having a feature quantity represented in a feature quantity space into any one of a predetermined number of classes.

2. Description of the Related Art

In the field of machine learning, there is an issue called “classification”. This issue represents, in the case where a predetermined number of classes into which data is classified are defined, an issue of predicting which of the classes the data is classified into based on a feature quantity of the data. For example, in a machine learning intended for image data, the issue of classification is handled as follows: defining a class into which image data including a specific object is classified; and predicting what object is included in each piece of image data based on a feature quantity of the image data.

In the classification, there are: what is called supervised classification in which the classification is performed by creating a classifier from learning data; and what is called unsupervised classification in which the classification is performed in a state where there is no learning data. As the supervised classification, there is known a support vector machine (SVM), for example. Further, as the unsupervised classification, there is known a cluster analysis, for example.

Here, in the supervised classification, since a criterion for classification is learned from the pieces of data which have already been classified into classes and data is classified by reflecting the criterion, the accuracy of the classification is high. However, in the supervised classification, it is difficult to classify data into a class into which data has not been classified. This is because it is difficult to acquire, from the class into which data has not been classified, learning data used for learning the criterion for the classification into the class. On the other hand, in the unsupervised classification, data can be classified into a class into which data has not been classified. However, since the unsupervised classification does not use learning data, the accuracy of the classification is low compared to the supervised classification. In particular, in performing the unsupervised classification to data having a high dimensional feature quantity, the accuracy of the classification is further deteriorated due to a phenomenon called curse of dimensionality, in which the generalization error stops being enhanced owing to increase in the dimensionality of the data. Accordingly, when performing the unsupervised classification to the data having a high dimensional feature quantity, there may be a case of performing dimensionality compression using an algorithm such as a principal component analysis (PCA) or an independent component analysis (ICA) and thereby decreasing the dimensionality of the feature quantity.

In such classification, there are developed technologies for enhancing accuracy of prediction. For example, in Thomas G. Dietterich and Ghulum Bakiri, “Solving Multiclass Learning Problems via Error-Correcting Output Codes”, Journal of Artificial Intelligence Research, 1995, Vol. 2, pp. 263-286, there is described a technology of classification using an error correcting output code (ECOC) which corrects an error of individual classifier by using a redundantly prepared classifier. Further, in Gabriella Csurka et al., “Visual Categorization with Bags of Keypoints”, Proc. of ECCV Workshop on Statistical Learning in Computer Vision, 2004, pp. 59-74, there is described a technology of classification using, in image data, a feature quantity called “Bag-of-keypoints” based on local pattern distribution.

### SUMMARY OF THE INVENTION

However, the ECOC described in Thomas G. Dietterich and Ghulum Bakiri, “Solving Multiclass Learning Problems via Error-Correcting Output Codes”, Journal of Artificial Intelligence Research, 1995, Vol. 2, pp. 263-286 is used on the premise that learning data for generating a classifier can be prepared. Accordingly, in order to classify data into a class having no data, it is still necessary to use the technique of the unsupervised classification of the past, and it is difficult to enhance the accuracy of the classification including a class with no learning data. Further, “Bag-of-keypoints” described in Gabriella Csurka et al., “Visual Categorization with Bags of Keypoints”, Proc. of ECCV Workshop on Statistical Learning in Computer Vision, 2004, pp. 59-74 is a feature quantity represented in a high dimensional sparse feature quantity space. Accordingly, when “Bag-of-keypoints” is used as it is for the unsupervised classification, it is largely influenced by the curse of dimensionality and the accuracy of the classification is lowered. Further, when attempting to perform dimensionality compression using the algorithm such as a PCA or an ICA to the “Bag-of-keypoints” feature quantity, there is a risk that only meaningless components are left behind due to influence of data distribution or a failure value. That is, it is difficult to perform dimensionality compression suitable for the classification. As a result, although there have been developed the technologies described in Thomas G. Dietterich and Ghulum Bakiri, “Solving Multiclass Learning Problems via Error-Correcting Output Codes”, Journal of Artificial Intelligence Research, 1995, Vol. 2, pp. 263-286, and Gabriella Csurka et al., “Visual Categorization with Bags of Keypoints”, Proc. of ECCV Workshop on Statistical Learning in Computer Vision, 2004, pp. 59-74, there was an issue that it was difficult to enhance the accuracy of the classification including a class with no learning data by using those technologies.

In light of the foregoing, it is desirable to provide an information processing apparatus, an information processing method, and a program, which are novel and improved, and which are capable of enhancing the accuracy of the classification including a class with no learning data.

According to an embodiment of the present invention, there is provided an information processing apparatus which includes a data pool generation section which generates an unknown data pool that contains, among data which is included in a data group and has a feature quantity represented in a feature quantity space, unknown data whose class to be classified into is unknown, a learning sample collection section which randomly extracts one piece of center data from the unknown data pool, extracts neighborhood data having a feature quantity which is located in a vicinity of a feature quantity of the center data in the feature quantity space, the neighborhood data being extracted in an ascending order of a distance of the feature quantity of the neighborhood data from the feature quantity of the center data in the feature quantity space until a number of pieces of the neighborhood data becomes a predetermined number, and collects a plurality of learning samples each containing the center data and the neighborhood data which have been extracted, a classifier generation section which generates a plurality of classifiers by using the plurality of learning samples which have been collected, an output feature quantity acquisition section which associates with the data, for each piece of the data included in the data group, a plurality of output values, which are obtained by inputting the data into the plurality of classifiers to identify the data, as an output feature quantity represented in an output feature quantity space different from the feature quantity space, and a classification section which classifies each piece of the unknown data included in the data group into any one of a predetermined number of the classes based on the output feature quantity.

With such a configuration, it is possible to classify the unknown data by using the output feature quantity having an expression suitable for the classification, which has been generated by learning in the feature quantity space, and to enhance the accuracy of the classification. In addition, it is possible to decrease the dimensionality of high dimensional feature quantity to the number equal to the number of the classifiers and to further enhance the accuracy of the classification.

The data pool generation section may further generate a known data pool which contains, among the data included in the data group, known data in which the class to be classified into is known and has a label of the class into which the known data is classified. The learning sample collection section may further randomly extract a predetermined number of pieces of the data from the known data pool having the label and may collect a learning sample containing the extracted data.

The learning sample collection section may determine a ratio of a number of learning samples formed of data extracted from the unknown data pool to a number of learning samples formed of data extracted from the known data pool depending on a ratio of a number of the classes into which the known data is classified to a number of the classes into which the known data is not classified.

The information processing apparatus may further include a dimensionality compression section which performs dimensionality compression to the output feature quantity. The classification section may classify the data based on the output feature quantity which has been subjected to the dimensionality compression by the dimensionality compression section.

Further, according to another embodiment of the present invention, there is provided an information processing method which includes generating an unknown data pool that contains, among data which is included in a data group and has a feature quantity represented in a feature quantity space, unknown data whose class to be classified into is unknown, randomly extracting one piece of center data from the unknown data pool, extracting neighborhood data having a feature quantity which is located in a vicinity of a feature quantity of the center data in the feature quantity space, the neighborhood data being extracted in an ascending order of a distance of the feature quantity from the feature quantity of the center data in the feature quantity space until a number of pieces of the neighborhood data becomes a predetermined number, and collecting a plurality of learning samples each containing the center data and the neighborhood data which have been extracted, generating a plurality of classifiers by using the plurality of learning samples which have been collected, associating with the data, for each piece of the data included in the data group, a plurality of output values, which are obtained by inputting the data into the plurality of classifiers and identifying the data, as an output feature quantity represented in an output feature quantity space different from the feature quantity space, and classifying each piece of the unknown data included in the data group into any one of a predetermined number of the classes based on the output feature quantity.

Further, according to another embodiment of the present invention, there is provided a program for causing a computer to execute processing of generating an unknown data pool that contains, among data which is included in a data group and has a feature quantity represented in a feature quantity space, unknown data whose class to be classified into is unknown, processing of randomly extracting one piece of center data from the unknown data pool, extracting neighborhood data having a feature quantity which is located in a vicinity of a feature quantity of the center data in the feature quantity space, the neighborhood data being extracted in an ascending order of a distance of the feature quantity from the feature quantity of the center data in the feature quantity space until a number of pieces of the neighborhood data becomes a predetermined number, and collecting a plurality of learning samples each containing the center data and the neighborhood data which have been extracted, processing of generating a plurality of classifiers by using the plurality of learning samples which have been collected, processing of associating with the data, for each piece of the data included in the data group, a plurality of output values, which are obtained by inputting the data into the plurality of classifiers and identifying the data, as an output feature quantity represented in an output feature quantity space different from the feature quantity space, and processing of classifying each piece of the unknown data included in the data group into any one of a predetermined number of the classes based on the output feature quantity.

According to the embodiments of the present invention described above, it is possible to enhance the accuracy of the classification including a class with no learning data.

### BRIEF DESCRIPTION OF THE DRAWINGS

FIG. 1 is a block diagram showing a functional configuration of an information processing apparatus according to an embodiment of the present invention;

FIG. 2 is a diagram illustrating a data group according to the embodiment;

FIG. 3 is a diagram illustrating a feature quantity of unknown data in a feature quantity space according to the embodiment;

FIG. 4 is a diagram illustrating a feature quantity of unknown data in the feature quantity space according to the embodiment for each class;

FIG. 5 is a flowchart showing a series of processing procedures according to the embodiment;

FIG. 6 is a diagram showing processing of generating a data pool according to the embodiment;

FIG. 7 is a diagram showing processing of collecting a learning sample according to the embodiment;

FIG. 8 is a diagram showing processing of generating a classifier according to the embodiment;

FIG. 9 is a diagram showing classification of known data performed by the classifier according to the embodiment;

FIG. 10 is a diagram showing classification of unknown data performed by the classifier according to the embodiment;

FIG. 11 is a diagram showing processing of acquiring an output feature quantity according to the embodiment;

FIG. 12 is a diagram illustrating an output feature quantity of unknown data in an output feature quantity space according to the embodiment;

FIG. 13 is a diagram illustrating an output feature quantity of unknown data in the output feature quantity space according to the embodiment for each class; and

FIG. 14 is a diagram illustrating a configuration of data which processing is intended for in a modified example of the embodiment of the present invention.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Embodiment of the present invention
1-1. Configuration of information processing apparatus
1-2. Classification processing

2. Modified example

3. Summary

### 1. EMBODIMENT OF THE PRESENT INVENTION

### 1-1. Configuration of Information Processing Apparatus

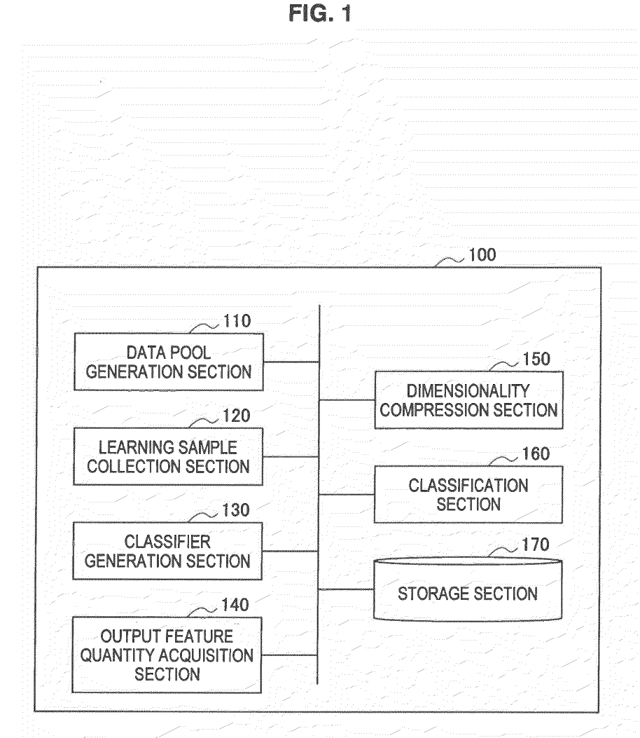

First, with reference to FIG. 1, a configuration of an information processing apparatus according to an embodiment of the present invention will be described.

FIG. 1 is a block diagram showing a functional configuration of an information processing apparatus 100 according to the embodiment of the present invention. Referring to FIG. 1, the information processing apparatus 100 includes a data pool generation section 110, a learning sample collection section 120, a classifier generation section 130, an output feature quantity acquisition section 140, a dimensionality compression section 150, a classification section 160, and a storage section 170. Note that, as will be described later, the information processing apparatus 100 may have a configuration which does not include the dimensionality compression section 150.

Of the above functional structural elements of the information processing apparatus 100, the data pool generation section 110, the learning sample collection section 120, the classifier generation section 130, the output feature quantity acquisition section 140, the dimensionality compression section 150, and the classification section 160 may be implemented as hardware with a circuit configuration including an integrated circuit, for example, or may be implemented as software by executing, by a CPU (Central Processing Unit), a program stored in a storage device or a removable storage medium that configures the storage section 170. In the storage section 170, there are implemented, in combination as necessary, a storage device such as a ROM (Read Only Memory) and a RAM (Random Access Memory), and a removable storage medium such as an optical disk, a magnetic disk, and a semiconductor memory.

The information processing apparatus 100 classifies data included in a data group stored in the storage section 170 into any one of a predetermined number of classes. Here, each piece of data has a feature quantity representing a feature of the data. The feature quantity is represented in a feature quantity space. For example, the feature quantity is a multidimensional vector, and the feature quantity space is a vector space in which a vector of the feature quantity is represented. In the data group, there is included unknown data whose class to be classified into is unknown. In the data group, there may also be included known data whose class to be classified into is known. Further, classes are each a set into which data has been classified based on some sort of criterion, and have labels for distinguishing the classes from each other.

The data pool generation section 110 generates a data pool which contains data included in a data group. Specifically, the data pool generation section 110 generates an unknown data pool containing unknown data, and a known data pool containing known data. Here, the unknown data pool is a single data pool which contains all pieces of unknown data. On the other hand, the known data pool has the same label as the label of the class, and the known data classified into the class is contained in the known data pool. Note that, in the case where there is no known data in the data group, the data pool generation section 110 only generates the unknown data pool.

The learning sample collection section 120 extracts a predetermined number of pieces of data from the data pool generated by the data pool generation section 110 as a learning sample and collects multiple pieces of learning samples. From the unknown data pool, a learning sample is collected by random sampling and nearest neighbor search. Specifically, the learning sample collection section 120 randomly extracts one piece of data from the unknown data pool, and let us assume that the data is center data. Next, the learning sample collection section 120 extracts neighborhood data having a feature quantity which is located in the vicinity of the feature quantity of the center data in the feature quantity space, the neighborhood data being extracted in ascending order of distance of the feature quantity from the feature quantity of the center data in the feature quantity space until the number of pieces of the neighborhood data becomes a predetermined number. The thus extracted center data and neighborhood data are set as a learning sample. On the other hand, from the known data pool, a learning sample is collected in accordance with the label of the data pool. Specifically, the learning sample collection section 120 randomly extracts a predetermined number of pieces of data from the known data pool that has the label, and the thus extracted data is set as a learning sample.

The classifier generation section 130 generates multiple classifiers by using the multiple learning samples collected by the learning sample collection section 120. The classifier outputs, with respect to the input data, a value for distinguishing a certain classification from another classification such as a distance from an identification hyperplane or a probability. As the classifier, there may be used a two-class classifier which distinguishes between two classifications. Note that, a target to be identified by the classifier generated by the classifier generation section 130 will be described later.

The output feature quantity acquisition section 140 inputs data included in the data group into the multiple classifiers generated by the classifier generation section 130. In addition, the output feature quantity acquisition section 140 acquires multiple output values obtained as a result of inputting the data into the multiple classifiers and identifying the data, and associates the obtained output values as an output feature quantity with the data. Here, the output feature quantity is a feature quantity represented in an output feature quantity space, which is different from the feature quantity space of the feature quantity that the data originally had. For example, the output feature quantity is a vector having the dimensionality equal to the number of classifiers, and the output feature quantity space is a vector space in which a vector of the output feature quantity is represented. Since the output feature quantity is generated by learning in the original feature quantity space, the output feature quantity has an expression suitable for the classification. Further, by setting the number of the classifiers to be generated by the classifier generation section 130, the dimensionality of the output feature quantity may be set lower than the dimensionality of the feature quantity that the data originally had.

The dimensionality compression section 150 is provided in the case where the output feature quantity, which has been acquired by the output feature quantity acquisition section 140 and has been associated with the data, is to be further decreased in dimensionality. The dimensionality compression section 150 performs dimensionality compression to the output feature quantity by using an algorithm such as a PCA or an ICA. Here, for example, let us assume the case where the feature quantity that the data originally had is a “Bag-of-keypoints” feature quantity. Since the “Bag-of-keypoints” feature quantity is a feature quantity represented in a high dimensional sparse feature quantity space, there is a risk that, when attempting to perform the dimensionality compression processing in the state as it is, only meaningless components are left behind due to influence of data distribution or a failure value. That is, there is a risk that the “Bag-of-keypoints” feature quantity is decreased in dimensionality in a form that is not suitable for the classification. On the other hand, since the output feature quantity includes the output values obtained from the classifiers as described above, the dimensionality compression processing can be performed without being directly influenced by data distribution or a failure value.

The classification section 160 classifies unknown data included in the data group into any one of a predetermined number of classes based on the output feature quantity. Here, for the classification of the unknown data, there may be used a technique of unsupervised classification such as a cluster analysis. Since the output feature quantity is generated by learning in the original feature quantity space, the output feature quantity has an expression suitable for the classification. Therefore, the accuracy of the unsupervised classification in the classification section 160 may be enhanced compared to the unsupervised classification using the original feature quantity. In addition, as described above, in the case where the dimensionality of the output feature quantity is lower than the dimensionality of the feature quantity that the data originally had, the accuracy of the unsupervised classification in the classification section 160 may be further enhanced. Moreover, in the case where known data is included in the data group, the output feature quantity includes the output values obtained from the classifiers, which has been generated from a learning sample of known data. In this case, an important feature for an actual classification is reflected on the output feature quantity, and hence, the accuracy of the unsupervised classification in the classification section 160 may be further enhanced.

The storage section 170 stores data necessary for processing in the information processing apparatus 100. For example, in the storage section 170, there is stored a data group to be a target of classification in the information processing apparatus 100. Further, in the storage section 170, there may also be temporarily stored data generated in processing performed in the respective sections of the information processing apparatus 100. In addition, in the case where respective functions of the information processing apparatus 100 are implemented as software, the storage section 170 may temporarily or permanently store a program which can realize the respective functions by being executed by a CPU.

The information processing apparatus 100 may include as necessary, in addition to the structural elements described above, structural elements (not shown) such as: a communication interface such as a USB (Universal Serial Bus) or a LAN (Local Area Network) for inputting/outputting information including a data group and a classification result; and an input device such as a keyboard or a mouse for acquiring an instruction of a user in executing processing or the like.

(1-2. Classification Processing)

(Data to be Target)

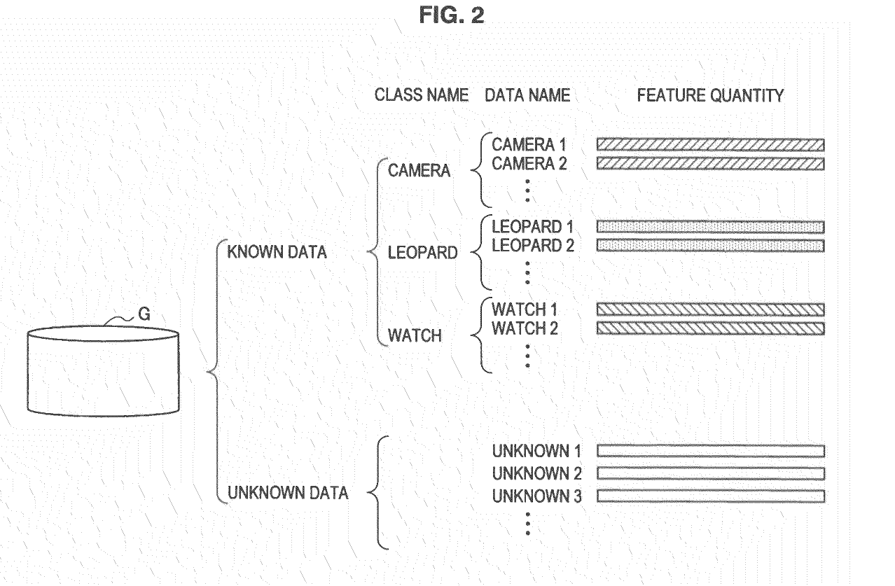

Next, with reference to FIGS. 2 to 4, data to be a target of classification processing according to the embodiment of the present invention will be described. Note that, hereinafter, the description will be made, as an example, on the case where the data to be a target of classification is image data including some sort of object, and a class into which the data is classified is the object included in the image. However, the embodiment of the present invention can be also applied to data other than the image data as long as the data has a feature quantity, such as audio data or moving image data. Further, hereinafter, the description will be made, as an example, on the case where the feature quantity that the data has is “Bag-of-keypoints” feature quantity. However, the embodiment of the present invention can be also applied to any other feature quantity as long as the feature quantity is represented in a feature quantity space. In particular, in the case where the dimensionality of the feature quantity that the data has is high, there can be obtained an effect more advantageous than the case of applying the embodiment of the present invention.

FIG. 2 is a diagram illustrating a data group G according to the embodiment of the present invention. Referring to FIG. 2, the data group G includes known data and unknown data. Note that, as described above, the data group G does not necessarily have to include the known data.

In the example shown in the figure, pieces of known data are classified into classes having labels of “camera”, “leopard”, and “watch”, respectively. For example, the pieces of data classified into the class having the label of “camera” are expressed as camera 1, camera 2, and so on in the figure. Those pieces of data are known, by some sort of method, to be pieces of image data each including a camera. In the same manner, the pieces of data classified into the class having the label of “leopard” are expressed as leopard 1, leopard 2, and so on, and the pieces of data classified into the class having the label of “watch” are expressed as watch 1, watch 2, and so on.

In the example shown in the figure, unknown data represents data which is not classified into any of the above three classes. The pieces of unknown data are expressed as unknown 1, unknown 2, unknown 3, and so on in the figure. The unknown data is not classified into classes at that point, but is decided to be classified into any one of the six classes of “bonsai”, “cup”, “notebook PC”, “ferry”, “panda”, and “sunflower” based on some sort of criterion. Therefore, the data included in the data group G shown in the example of the figure is classified into any one of the nine classes including the known three classes.

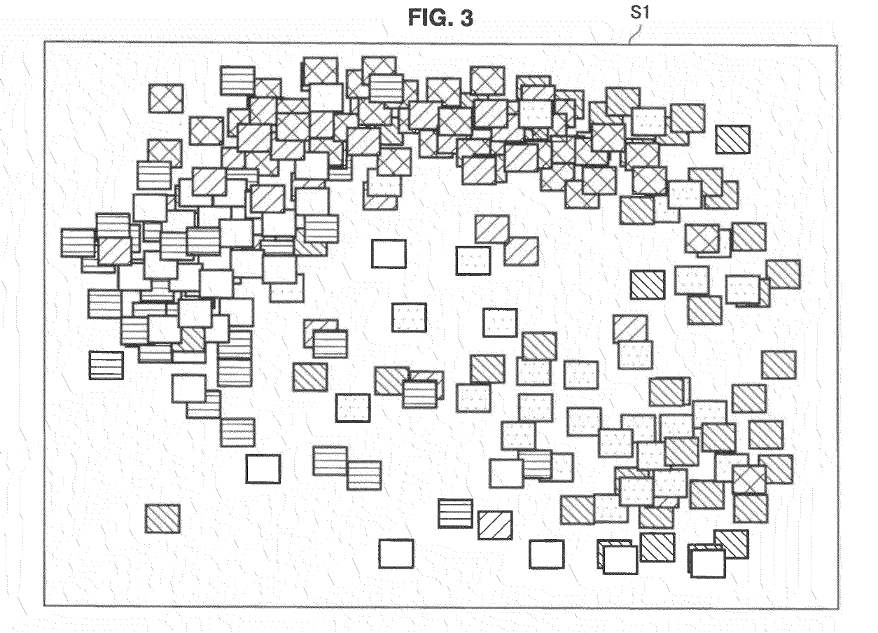

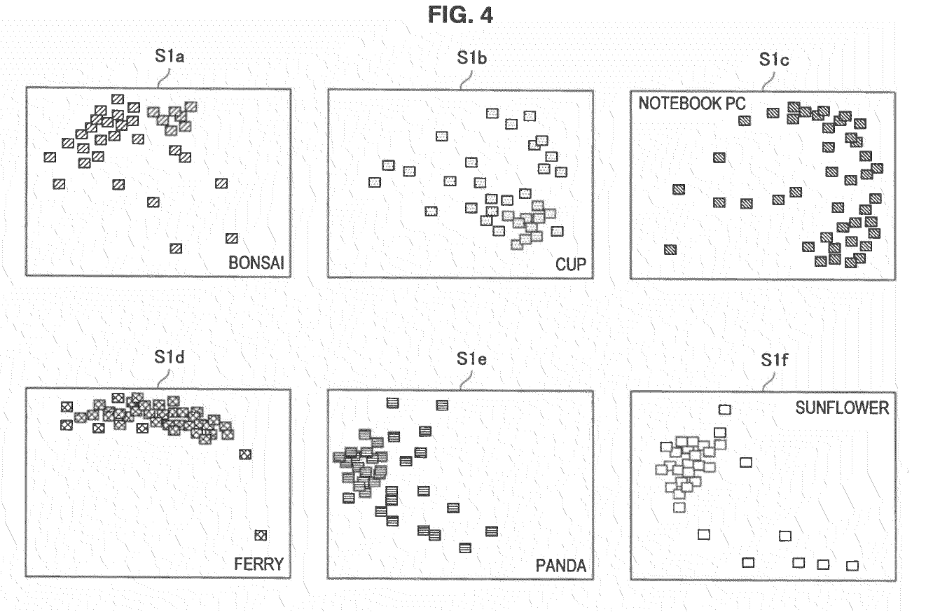

The data of the data group G, which includes the known data and the unknown data, has a feature quantity. Here, in the known data for example, on a feature quantity of the data classified into the class having the “camera” label, a feature of an image including a camera is reflected. In the same manner, on a feature quantity of the data classified into the class having the “leopard” label, a feature of an image including a leopard is reflected. Further, on a feature quantity of the data classified into the class having the “watch” label, a feature of an image including a watch is reflected. On the other hand, for the six classes of “bonsai”, “cup”, “notebook PC”, “ferry”, “panda”, and “sunflower”, into which the unknown data is classified, it is unknown what sort of a feature quantity tendency the data classified into each class has. Here, the feature quantity of the unknown data will be further described with reference to FIGS. 3 and 4.

FIG. 3 is a diagram illustrating a feature quantity of unknown data in a feature quantity space S1 according to the embodiment of the present invention. FIG. 4 is a diagram illustrating a feature quantity of unknown data in the feature quantity space S1 according to the embodiment of the present invention for each class. Referring to FIG. 3, there is illustrated the feature quantity space S1 in which a feature quantity of the unknown data included in the data group G is represented. Referring to FIG. 4, there are illustrated feature quantity spaces S1a to S1f, which represent feature quantities of the respective pieces of unknown data classified into six classes of “bonsai”, “cup”, “notebook PC”, “ferry”, “panda”, and “sunflower”. Note that, in FIGS. 3 and 4, respective feature quantities are projected into two dimensions using a Sammon map.

As illustrated in FIGS. 3 and 4, the respective feature quantities of the unknown data classified into respective classes are distributed in the feature quantity space S1 with a certain degree of tendency for each class. However, for example, the “panda” class represented in the feature quantity space S1e and the “sunflower” class represented in the feature quantity space S1f are shown in a manner that most of the parts thereof are overlapped in the feature quantity space S1. Accordingly, in the classification with low accuracy, it is difficult to accurately classify the unknown data into those classes. Here, since the feature quantity that the unknown data has is a “Bag-of-keypoints” feature quantity which is a high dimensional feature quantity, in the case of performing the unsupervised classification such as a cluster analysis by using the feature quantity of the unknown data, the accuracy of the classification becomes low due to the influence of the curse of dimensionality described above, and it becomes difficult to accurately classify the unknown data into classes. The data classification processing according to the embodiment of the present invention particularly achieves advantageous effect in the case of such data. Hereinafter, processes of steps of the data classification processing will be described.

(Data Pool Generation Processing)

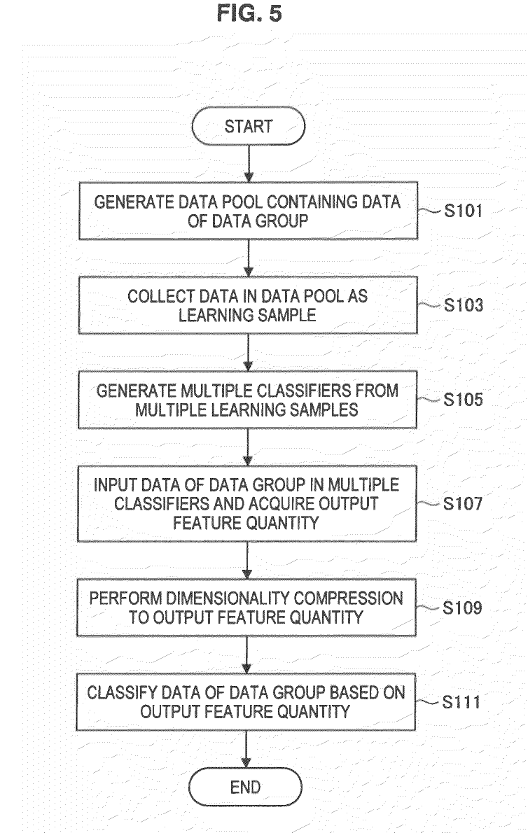

Next, with reference to FIGS. 5 to 13, a series of processing procedures of the classification according to the embodiment of the present invention will be described. FIG. 5 is a flowchart showing a series of processing procedures according to the embodiment of the present invention. Hereinafter, with reference to the flowchart shown in FIG. 5 as occasion arises, and also with reference to other figures, there will be described the classification processing performed in the information processing apparatus 100.

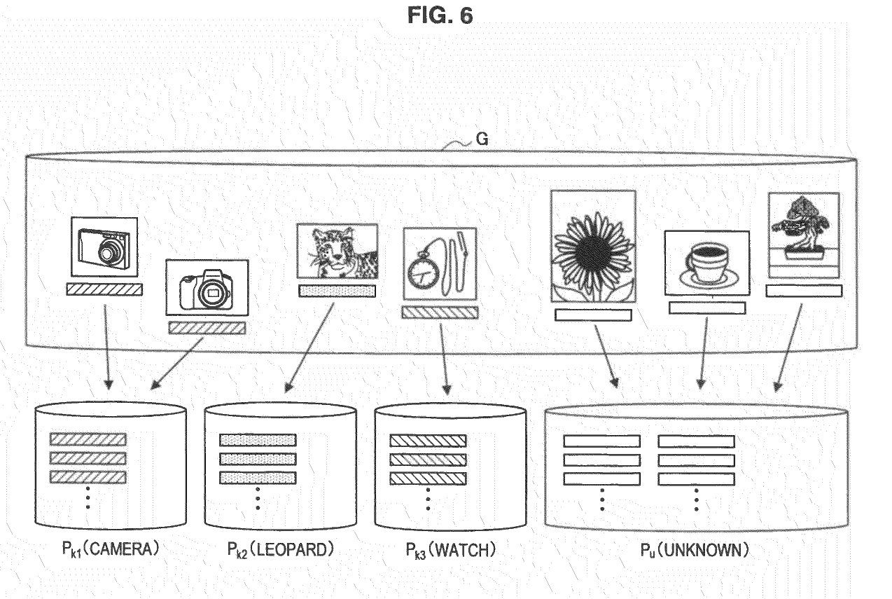

Referring to FIG. 5, first, the data pool generation section 110 generates a data pool which contains data of the data group G (Step S101). Here, processing of generating a data pool will be described with reference to FIG. 6.

FIG. 6 is a diagram showing processing of generating a data pool P according to the embodiment of the present invention. Referring to FIG. 6, an unknown data pool Pᵤ is generated, which contains unknown data whose class to be classified into is unknown among the data included in the data group G. In the example shown in the figure, the image data including a sunflower, the image data including a cup, and the image data including a bonsai are contained in the unknown data pool Pᵤ as the unknown data. Although there is one unknown data pool Pᵤ in the example shown in the figure, there may be generated multiple unknown data pools P.

In addition, in the case where known data whose class to be classified into is known is present in the data group G, a known data pool Pₖ which contains the known data is generated. The known data pool Pₖ has a label of a class into which the known data contained therein is classified. In the example shown in the figure, there are generated a known data pool Pₖ (label of which is “camera”) which contains known data classified into the class having the “camera” label, a known data pool Pₖ₂ (label of which is “leopard”) which contains known data classified into the class having the “leopard” label, and a known data pool Pₖ₃ (label of which is “watch”) which contains known data classified into the class having the “watch” label.

(Learning Sample Collection Processing)

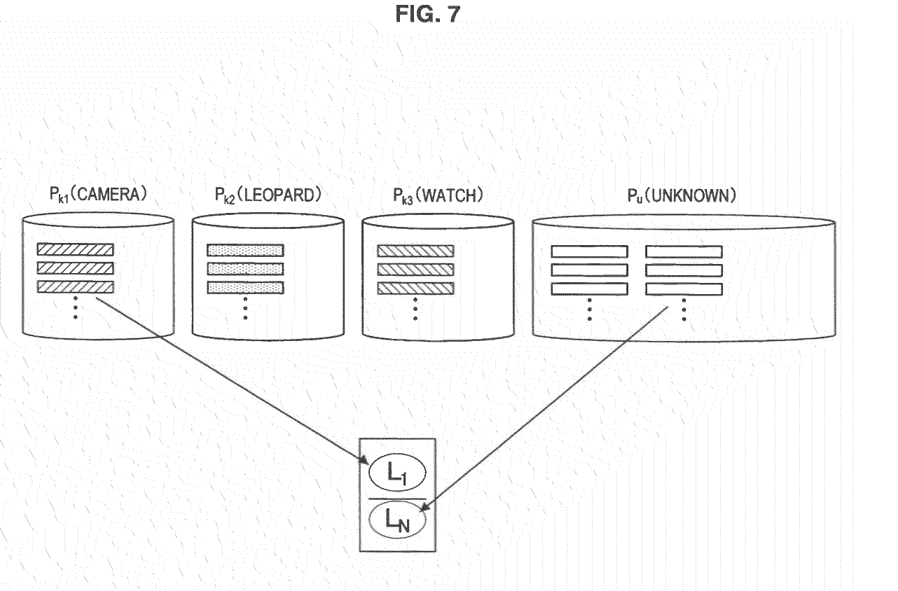

With reference to FIG. 5 again, subsequently, the learning sample collection section 120 collects data contained in a data pool as a learning sample (Step S103). Here, processing of collecting the learning sample will be described with reference to FIG. 7.

FIG. 7 is a diagram showing processing of collecting a learning sample L according to the embodiment of the present invention. Referring to FIG. 7, a learning sample L_{N} is collected from an unknown data pool Pᵤ, and a learning sample L₁ is collected from a known data pool Pₖ₁. The learning sample collection may be performed by repeating the following processing: extracting a predetermined number of pieces of data contained in any one of the data pools, the predetermined number being sufficient for generating a classifier in the succeeding processing; and setting the extracted predetermined number of pieces of data as one learning sample L.

The learning sample L_{N} from the unknown data pool Pᵤ is collected with a limitation on a distance in the feature quantity space S1. First, one piece of center data is randomly extracted from the unknown data pool Pᵤ. The center data may be extracted from anywhere in the unknown data pool Pᵤ. Next, neighborhood data with respect to the center data is extracted. Here, the neighborhood data has a feature quantity which is located in the vicinity of the feature quantity of the center data in the feature quantity space S1. The neighborhood data is extracted until the number of the pieces of extracted data including the center data becomes a predetermined number, the neighborhood data being extracted in an ascending order of a distance of the feature quantity from the feature quantity of the center data in the feature quantity space S1. For the extraction of the neighborhood data, an algorithm of nearest neighbor search may be used. A group of data included in the learning sample L_{N} collected from the unknown data pool Pᵤ by such processing are random in the locations in the feature quantity space S1, but has a feature that pieces of data are located close to each other in the feature quantity space S1.

On the other hand, the learning sample L₁ from the known data pool Pₖ₁ is collected with a limitation on the label of the data pool. Here, only a predetermined number of pieces of data are randomly extracted from the known data pool Pₖ₁. A group of data included in the learning sample L₁ collected from the known data pool Pₖ₁ consists only of the data contained in the known data pool Pₖ₁, and the data contained in another known data pool such as the known data pool Pₖ₂ or Pₖ₃ or the unknown data pool Pᵤ is not included.

In the case where known data is present in the data group G, a ratio of the number of learning samples L formed of data extracted from the unknown data pool Pᵤ to the number of learning samples L formed of data extracted from the known data pool Pₖ may be determined depending on a ratio of the number of classes into which the known data is classified to the number of classes into which the known data is not classified. A specific description thereof will be made on the case of an example shown in the figure. In the example shown in the figure, the number of predetermined number of classes is nine, and of those, three classes (“camera”, “leopard”, and “watch”) are the classes into which known data is classified, and the other six classes (“bonsai”, “cup”, “notebook PC”, “ferry”, “panda”, and “sunflower”) are the classes into which the known data is not classified. In this case, the proportions of the learning samples L to be collected are one from the known data pool Pₖ₁, one from the known data pool Pₖ₂, one from the known data pool Pₖ₃, and six from the unknown data pool Pᵤ. That is, in the case where 10 learning samples L were collected from the known data pool Pₖ₁, there are also collected 10 learning samples L from the known data pool Pₖ₂, also 10 learning samples L from the known data pool Pₖ₃, and 60 learning samples L from the unknown data pool Pᵤ. By generating a classifier using the thus collected learning sample L in succeeding step, there can be generated multiple classifiers which are compatible with all the classes without bias, and the accuracy of the classification into respective classes can be enhanced without bias.

(Classifier Generation Processing)

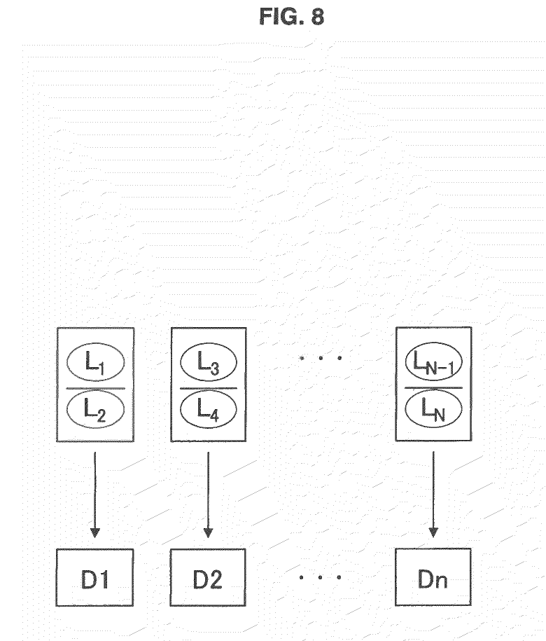

With reference to FIG. 5 again, subsequently, the classifier generation section 130 generates multiple classifiers from the multiple learning samples L which have been collected (Step S105). Here, processing of generating the classifiers will be described with reference to FIGS. 8 to 10.

FIG. 8 is a diagram showing processing of generating a classifier D according to the embodiment of the present invention. Referring to FIG. 8, a classifier D1 is generated by using a learning sample L₁ and a learning sample L₂, a classifier D2 is generated by using a learning sample L₃ and a learning sample L₄, and, until a classifier Dn is generated by using a learning sample L_{N-1} and a learning sample L_{N} in the same manner, n-classifiers in total are generated. Here, as an example of the classifier D, there is used a two-class classifier (one-versus-one classifier). The two-class classifier outputs, with respect to input data, a real number value for dividing the data into two classifications, such as a distance from an identification hyperplane or a probability. For generating such a two-class classifier, there may be used an algorithm of supervised classification such as an SVM. Multiple learning samples L used for generating the classifier D are collected by the learning sample collection section 120 in Step S103. It is desirable that the classifier generation section 130 uses the multiple learning samples L without bias and generates multiple classifiers D.

In the example above, the two classifications to be targets of identification of the classifier D are given by two learning samples from which the classifier D was generated. For example, let us assume that the learning sample L₁ is collected from the known data pool Pₖ₁, and the learning sample L₂ is collected from the known data pool Pₖ₂. In this case, the classifier D1 sets the data included in the known data pool Pₖ₁ and the data included in the known data pool Pₖ₂ as two classifications, identifies input data, and outputs a value for dividing the data into the two classifications. That is, the classifier D1 distinguishes the known data classified into the class having the “camera” label from the known data classified into the class having the “leopard” label.

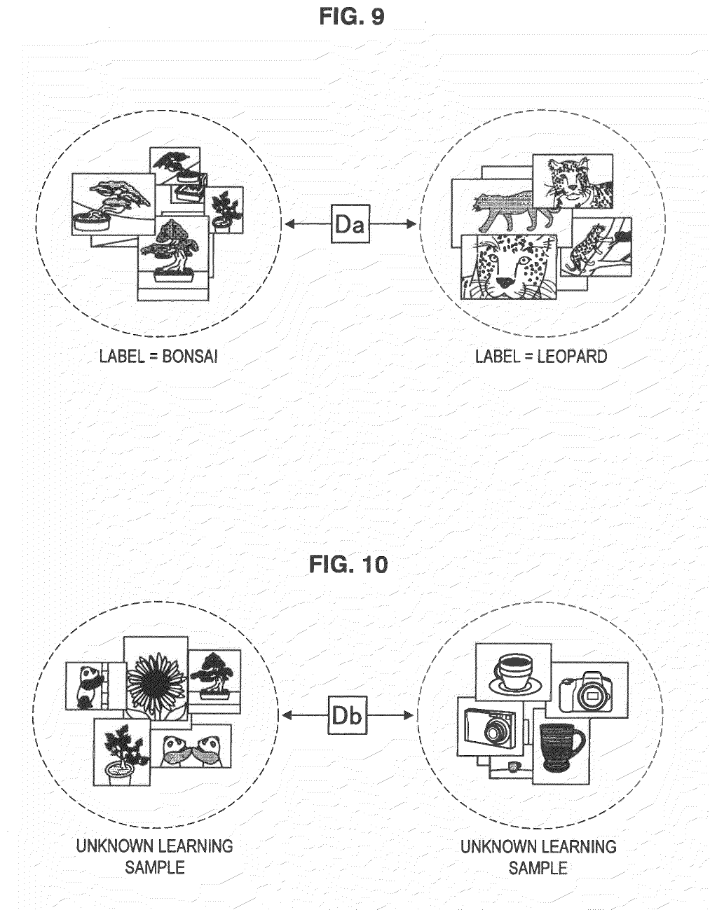

Further, in another example, let us assume that a learning sample L_{N-1} is collected from an unknown data pool Pᵤ, and a learning sample L_{N} is also collected from the unknown data pool Pᵤ. In this case, the classifier Dn sets, among the unknown data included in the unknown data pool Pᵤ, a group of unknown data located close to each other somewhere in the feature quantity space S1 and a group of unknown data located close to each other somewhere other than the location of the former group in the feature quantity space S1 as two classifications, and outputs a value for dividing the input data into the two classifications. That is, the classifier Dn distinguishes: the pieces of unknown data, although not classified into classes at that point, which are considered to have some sort of similarity to each other as a result of being represented in the feature quantity space S1; from the pieces of unknown data, although also not classified into classes at that point, which are considered to have some sort of similarity to each other which is other than the similarity between the former pieces of unknown data as a result of being represented in the feature quantity space S1. With reference to FIGS. 9 and 10, operation of such a classifier D will be further described.

FIG. 9 is a diagram showing classification of known data performed by a classifier D according to the embodiment of the present invention. Referring to FIG. 9, a classifier Da is generated by using a predetermined number of pieces of known data classified into a class having the “bonsai” label as a learning sample and a predetermined number of pieces of known data classified into a class having the “leopard” label as a learning sample. Accordingly, some sort of feature point of the data classified into the class having the “bonsai” label and some sort of feature point of the data classified into the class having the “leopard” label are reflected on the classifier Da. Therefore, the classifier Da distinguishes the data classified into the class having the “bonsai” label from the data classified into the class having the “leopard” label. For example, in the case where known data which is classified into the class having the “bonsai” label is input, the classifier Da ouputs a value indicating that the input data is classified into “bonsai”. Further, in the case where unknown data which is not classified into any of the classes having the “bonsai” label or the “leopard” label is input, the classifier Da ouputs a value indicating which of “bonsai” and “leopard” the input data is closer to and how close the input data is to either of “bonsai” or “leopard”.

FIG. 10 is a diagram showing classification of unknown data performed by the classifier D according to the embodiment of the present invention. Referring to FIG. 10, a classifier Db is generated by using a predetermined number of pieces of unknown data located in the vicinity of a certain position in the feature quantity space S1 (sunflower, panda, and the like in the example shown in the figure) as a learning sample and a predetermined number of pieces of unknown data located in the vicinity of another position in the feature quantity space S1 (camera, cup, and the like in the example shown in the figure) as a learning sample. Accordingly, some sort of feature point of the data located in the vicinity of the certain position in the feature quantity space S1 and some sort of feature point of the data located in the vicinity of the other position in the feature quantity space S1 are reflected on the classifier Db. Therefore, the classifier Db distinguishes data located in the vicinity of a certain point in the feature quantity space S1 from data located in the vicinity of another point in the feature quantity space S1. For example, in the case where data, which is located at a position close to the position of the data such as sunflower and panda included in the left group in the figure, is input, the classifier Db ouputs a value indicating that the input data is close to the left group in the figure.

In this manner, the classifier D outputs, with respect to the input data represented in the feature quantity space S1, a value for distinguishing between two classifications into which the data is to be classified based on some sort of criterion. In the example shown in FIG. 9, the classifier Da classifies the input data based on the criterion which of the classes of “bonsai” and “leopard” the input data is closer to. That is, the output value from the classifier Da is a real number value indicating which of bonsai and leopard the input data is closer to. On the other hand, in the example shown in FIG. 10, the classifier Db classifies the input data based on the criterion which of the positions in the feature quantity space S1, at which respective two groups of unknown data are located, the input data is closer to. That is, the output value from the classifier Db is a real number value indicating which of the two groups of data having some sort of similarity within each group in the feature quantity space S1 the input data is closer to.

(Output Feature Quantity Acquisition Processing)

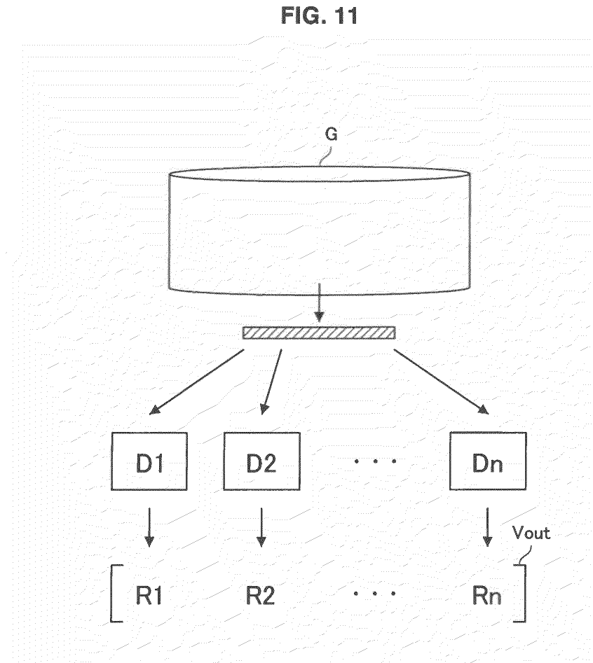

With reference to FIG. 5 again, subsequently, the output feature quantity acquisition section 140 acquires an output feature quantity by inputting data of the data group G in each of the multiple classifiers D and identifying the data (Step S107). Here, processing of acquiring the output feature quantity will be described with reference to FIGS. 11 to 13.

FIG. 11 is a diagram showing processing of acquiring an output feature quantity Vₒᵤₜ according to the embodiment of the present invention. Referring to FIG. 11, the output feature quantity Vₒᵤₜ includes as elements n-output values R1, R2, . . . , and Rn. The output values R1, R2, . . . , and Rn are output as results of inputting one piece of data included in the data group G in each of n-classifiers D1, D2, . . . , and Dn generated by the classifier generation section 130 and identifying the piece of data. The output feature quantity acquisition section 140 acquires output feature quantity Vₒᵤₜ for each piece of data included in the data group G, and associates the output feature quantity Vₒᵤₜ with the data. The output feature quantity Vₒᵤₜ is a vector having the dimensionality equal to the number of classifiers D. Accordingly, by setting the number of classifiers D generated by the classifier generation section 130, the dimensionality of the output feature quantity Vₒᵤₜ can be set. Therefore, for example, in the case where an original feature quantity that the data has is a “Bag-of-keypoints” feature quantity which is a high dimensional feature quantity, there can be acquired the output feature quantity Vₒᵤₜ at a dimensionality lower than the original dimensionality by setting the number of classifiers D to be smaller than the dimensionality of the feature quantity. Therefore, accuracy deterioration can be suppressed in the unsupervised classification such as a cluster analysis of unknown data.

Here, an output value R, which is an element of the output feature quantity Vₒᵤₜ, will be further described. For example, the output feature quantity Vₒᵤₜ includes the output value R1 of the classifier D1. As described with reference to FIG. 8, the classifier D1 is a two-class classifier generated by using the learning sample L₁ extracted from the known data pool Pₖ₁ having the “camera” label and the learning sample L₂ extracted from the known data pool Pₖ₂ having the “leopard” label. Accordingly, the output value R1 of the classifier D1 is a real number value indicating which of camera and leopard the input data is closer to.

Further, the output feature quantity Vₒᵤₜ includes the output value Rn of the classifier Dn. As described with reference to FIG. 8, the classifier Dn is a two-class classifier generated by using the learning sample L_{N-1} which is contained in the unknown data pool Pᵤ and which includes a group of unknown data located close to each other somewhere in the feature quantity space S1, and the learning sample L_{N} which is also contained in the unknown data pool Pᵤ and which includes a group of unknown data located close to each other somewhere other than the location of the former group in the feature quantity space S1. Accordingly, the output value Rn of the classifier Dn is a real number value indicating which of the two groups of data having some sort of similarity within each group in the feature quantity space S1 the input data is closer to.

In this manner, the output feature quantity Vₒᵤₜ sets, as an element, an output value R indicating which of two groups of data having some sort of similarity within each group the data is closer to. Here, some sort of similarity in a classifier D generated by including a learning sample L extracted from unknown data is the closeness in terms of distance in the feature quantity space S1 in the case of representing the data in the feature quantity space S1. The data of the learning sample to be extracted first from the unknown data is randomly extracted among the unknown data. Accordingly, when the number of learning samples L extracted from the unknown data is sufficiently large, the multiple output values R of the multiple classifiers D generated by including learning samples L extracted from the unknown data can reflect comprehensively to some extent distribution of the unknown data in the feature quantity space S1.

Further, some sort of similarity in a classifier D generated by including a learning sample L extracted from known data is a given label that the class into which the known data is classified has. Note that, as described above, in the embodiment of the present invention, the known data is not necessarily present. However, in the case where the known data is present, it is possible to retrieve a result of classification based on an important feature in an actual classification from the known data, such as “which of the camera and leopard is the data closer to”, and include the result into the output feature quantity Vₒᵤₜ as an output value R. In this way, in the case where known data and unknown data are mixed, classification of the unknown data can be performed with higher accuracy than the case of the unsupervised classification intended for only unknown data.

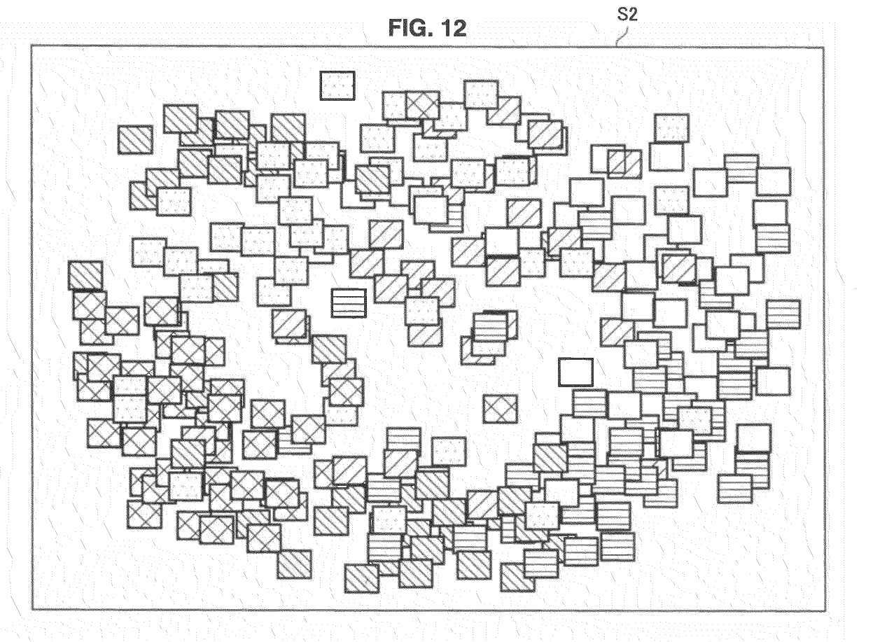

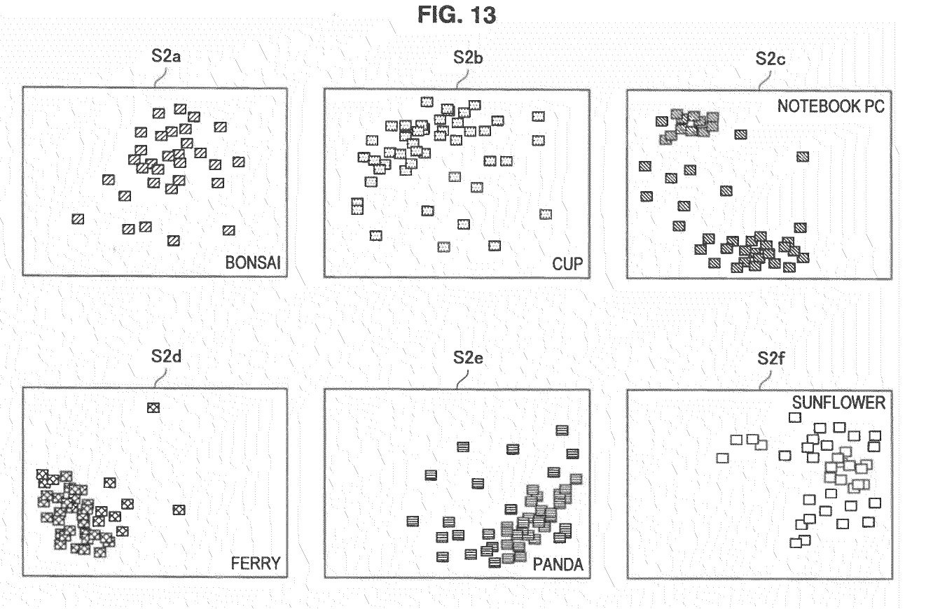

FIG. 12 is a diagram illustrating an output feature quantity Vₒᵤₜ of unknown data in an output feature quantity space S2 according to the embodiment of the present invention. FIG. 13 is a diagram illustrating an output feature quantity Vₒᵤₜ of unknown data in the output feature quantity space S2 according to the embodiment of the present invention for each class. Referring to FIG. 12, there is illustrated the output feature quantity space S2 in which an output feature quantity Vₒᵤₜ of the unknown data included in the data group G is represented. Referring to FIG. 13, there are illustrated output feature quantity spaces S2a to S2f which represent output feature quantities Vₒᵤₜ of the respective pieces of unknown data classified into six classes of “bonsai”, “cup”, “notebook PC”, “ferry”, “panda”, and “sunflower”. Note that, in FIGS. 12 and 13, respective output feature quantities Vₒᵤₜ are projected into two dimensions using a Sammon map.

As illustrated in FIGS. 12 and 13, in the output feature quantity space S2, the output feature quantities Vₒᵤₜ of respective classes are distributed in a more biased manner compared to the feature quantity space S1. For example, referring to the output feature quantity space S2e and the output feature quantity space S2f, the “panda” class and the “sunflower” class, which have been represented in a manner that most of the parts thereof are overlapped in the feature quantity space S1, are each distributed in a biased manner in different directions. In this way, the output feature quantity space S2 is a feature quantity space different from the feature quantity space S1. Therefore, the output feature quantities Vₒᵤₜ of respective pieces of data distributed in the output feature quantity space S2 may be distributed with a tendency different from the feature quantities of respective pieces of data distributed in the feature quantity space S1.

(Output Feature Quantity-Dimensionality Compression Processing)

With reference to FIG. 5 again, subsequently, the dimensionality compression section 150 performs dimensionality compression to the output feature quantity Vₒᵤₜ (Step S109). This step is executed as necessary. That is, Step S109 is executed in the case of further decreasing the dimensionality of the output feature quantity Vₒᵤₜ generated in Step S107. For example, in order to comprehensively reflect distribution of unknown data in the feature quantity space S1 on output value R, the dimensionality of the output feature quantity Vₒᵤₜ becomes high in the case where the number of classifiers D generated in Step S105 is set to be large. In such a case, accuracy deterioration can be suppressed in the unsupervised classification such as a cluster analysis of unknown data by performing dimensionality compression to the output feature quantity Vₒᵤₜ in Step S109.

An algorithm such as a PCA, an ICA, or a multidimensional scaling (MDS) may be used for the dimensionality compression in Step S109. Here, an output value R of a classifier D, which is an element of the output feature quantity Vₒᵤₜ, is a real number value for dividing data into two classifications, such as a distance from an identification hyperplane or a probability. Accordingly, even when the algorithm such as the PCA, the ICA, or the MDS is used for the dimensionality compression of the output feature quantity Vₒᵤₜ, it is hardly likely that the dimensionality compression is influenced by a failure value included in an original feature quantity that the data has, data distribution, and the like. Further, here, in the case where known data is present in the data group G, when the output value R of the classifier D generated by including the known data is included in the output feature quantity Vₒᵤₜ to be subjected to the dimensionality compression, the dimensionality compression can be performed by capturing an important feature in an actual classification.

(Data Classification Processing Based on Output Feature Quantity)

Subsequently, the classification section 160 classifies unknown data included in the data group G based on the output feature quantity Vₒᵤₜ of each piece of data (Step S111). For the classification of the unknown data, although there may be used a technique of unsupervised classification such as a cluster analysis, the accuracy of the classification is more enhanced than in the past. This is because there is used an output feature quantity Vₒᵤₜ having an expression suitable for the classification, which has been generated by learning in the original feature quantity space S1. Further, it is because the multidimensional feature quantity that the data has is converted into the output feature quantity Vₒᵤₜ whose dimensionality is decreased to the number equal to the number of the classifiers D, and hence, the accuracy deterioration of the classification caused by the so-called curse of dimensionality can be suppressed. In addition, in the case of performing the dimensionality compression to the output feature quantity Vₒᵤₜ in Step S109, the dimensionality of the output feature quantity Vₒᵤₜ can be further decreased, and the accuracy of the classification can be further enhanced. Still further, in the case where known data is present in the data group G, an important feature in an actual classification can be reflected on the learning for generating the output feature quantity Vₒᵤₜ and on the dimensionality compression, and the accuracy of the classification can be further enhanced.

### 2. MODIFIED EXAMPLE

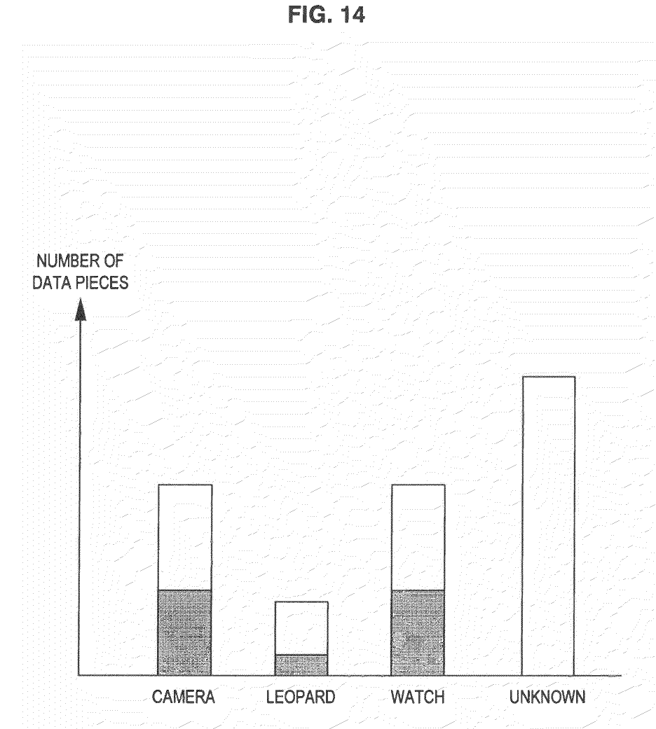

Next, referring to FIG. 14, a modified example of the embodiment of the present invention will be described. Note that the functional configuration other than a configuration of data to be a target, which will be described below, is almost the same as the embodiment of the present invention described above, so the detailed description thereof is omitted.

FIG. 14 is a diagram illustrating a configuration of data which processing is intended for in the modified example of the embodiment of the present invention. Referring to FIG. 14, the data which the processing is intended for includes known data represented by a hatched part and unknown data represented by another part. Here, the known data is classified into any one of three classes (a class having a “camera” label, a class having a “leopard” label, and a class having a “watch” label). In the unknown data, in addition to data classified into a class other than the above three classes, there is included data which is to be classified into the above one of the three classes but is set as unknown data at that time point. That is, in this modified example, the unknown data may be classified into any one of the nine classes of “camera”, “leopard”, “watch”, “bonsai”, “cup”, “notebook PC”, “ferry”, “panda”, and “sunflower”.

In this case, a learning sample L is also collected from unknown data which is to be classified into the classes (“camera”, “leopard”, and “watch”) into which the known data is classified, in the same manner as the other unknown data. That is, the learning sample L collected from the unknown data is collected with a limitation on a distance. Further, a learning sample from the known data is collected from data (hatched part in the figure) which is recognized as known data. In this way, the embodiment of the present invention can be applied to the processing of classification of the data including unknown data which is to be further classified into the class into which the known data is classified.

### 3. SUMMARY

In the embodiment of the present invention described above, unknown data included in the data group G is classified into any one of a predetermined number of classes by using an output feature quantity Vₒᵤₜ which is different from a feature quantity of the data. Here, the output feature quantity Vₒᵤₜ includes output values R of multiple classifiers D generated by using multiple learning samples L which have been extracted with a limitation on a distance of a feature quantity of each data in the feature quantity space S1 in which the feature quantity of data is represented. With such a configuration, it is possible to classify the unknown data by using the output feature quantity Vₒᵤₜ having an expression suitable for the classification, which has been generated by learning in the feature quantity space S1, and to enhance the accuracy of the classification. Further, it is possible to decrease the dimensionality of high dimensional feature quantity to the number equal to the number of the classifiers D, and to further enhance the accuracy of the classification.

Further, in the embodiment of the present invention, in the case where known data whose class to be classified into is known is included in the data group G, it may be configured in a manner to collect a learning sample L also from the known data with a limitation on a label of the class to be classified into. With such a configuration, it is possible to generate the classifier D on which an important feature in an actual classification is reflected, to perform classification using the output feature quantity Vₒᵤₜ including the output value R output from the classifier D, and to further enhance the accuracy of the classification.

Still further, in the embodiment of the present invention, in the case where known data whose class to be classified into is known is present in the data group G, it may be configured in the following manner: a ratio of learning samples L collected from unknown data to learning samples L collected from known data is determined depending on a ratio of the number of classes into which the known data is classified to the number of classes into which the known data is not classified among a predetermined number of classes. With such a configuration, it is possible to perform classification into each class using the output feature quantity Vₒᵤₜ including the output value R of the classifier D which is generated from the learning sample L collected without bias, and to enhance the accuracy of the classification into each class without bias.

In addition, in the embodiment of the present invention, it may be configured in a manner that the dimensionality compression is further performed to the output feature quantity Vₒᵤₜ. With such a configuration, it is possible to keep the dimensionality of the output feature quantity Vₒᵤₜ used for the classification low even when the number of classifiers D is set to be large, and to achieve sufficient learning in the feature quantity space S1 and the accuracy of the classification at the same time.

It should be understood by those skilled in the art that various modifications, combinations, sub-combinations and alterations may occur depending on design requirements and other factors insofar as they are within the scope of the appended claims or the equivalents thereof.

For example, in the embodiment described above, image data is used as the data to be a target of the classification, but the embodiment of the present invention is not limited to such an example. For example, every piece of data having a feature quantity, such as audio data, moving image data, or text data, may be a target of the classification to which the embodiment of the present invention is applied.

Further, in the embodiment described above, the feature quantity that the image data as an example of data to be a target of the classification is the “Bag-of-keypoints” feature quantity, but the embodiment of the present invention is not limited to such an example. For example, the feature quantity may be another feature quantity such as a SIFT feature quantity.

Still further, in the embodiment described above, the two-class classifier is used as the classifier, but the embodiment of the present invention is not limited to such an example. For example, there may be used another kind of classifier such as a one-versus-the-rest classifier.

The present application contains subject matter related to that disclosed in Japanese Priority Patent Application JP 2010-121272 filed in the Japan Patent Office on May 27, 2010, the entire content of which is hereby incorporated by reference.

What is claimed is:

1. An information processing apparatus comprising:
a data pool generation section which generates an unknown data pool that contains, among data which is included in a data group and has a feature quantity represented in a feature quantity space, unknown data whose class to be classified into is unknown;
a learning sample collection section which randomly extracts one piece of center data from the unknown data pool, extracts neighborhood data having a feature quantity which is located in a vicinity of a feature quantity of the center data in the feature quantity space, the neighborhood data being extracted in an ascending order of a distance of the feature quantity of the neighborhood data from the feature quantity of the center data in the feature quantity space until a number of pieces of the neighborhood data becomes a predetermined number, and collects a plurality of learning samples each containing the center data and the neighborhood data which have been extracted;
a classifier generation section which generates a plurality of classifiers by using the plurality of learning samples which have been collected;
an output feature quantity acquisition section which associates with the data, for each piece of the data included in the data group, a plurality of output values, which are obtained by inputting the data into the plurality of classifiers to identify the data, as an output feature quantity represented in an output feature quantity space different from the feature quantity space; and
a classification section which classifies each piece of the unknown data included in the data group into any one of a predetermined number of the classes based on the output feature quantity.

2. The information processing apparatus according to claim 1,
wherein the data pool generation section further generates a known data pool which contains, among the data included in the data group, known data in which the class to be classified into is known and has a label of the class into which the known data is classified, and
wherein the learning sample collection section further randomly extracts a predetermined number of pieces of the data from the known data pool having the label and collects a learning sample containing the extracted data.

3. The information processing apparatus according to claim 2,
wherein the learning sample collection section determines a ratio of a number of learning samples formed of data extracted from the unknown data pool to a number of learning samples formed of data extracted from the known data pool depending on a ratio of a number of the classes into which the known data is classified to a number of the classes into which the known data is not classified.

4. The information processing apparatus according to claim 1, further comprising
a dimensionality compression section which performs dimensionality compression to the output feature quantity,
wherein the classification section classifies the data based on the output feature quantity which has been subjected to the dimensionality compression by the dimensionality compression section.

5. An information processing method comprising:
generating an unknown data pool that contains, among data which is included in a data group and has a feature quantity represented in a feature quantity space, unknown data whose class to be classified into is unknown;
randomly extracting one piece of center data from the unknown data pool, extracting neighborhood data having a feature quantity which is located in a vicinity of a feature quantity of the center data in the feature quantity space, the neighborhood data being extracted in an ascending order of a distance of the feature quantity of the neighborhood data from the feature quantity of the center data in the feature quantity space until a number of pieces of the neighborhood data becomes a predetermined number, and collecting a plurality of learning samples each containing the center data and the neighborhood data which have been extracted;
generating a plurality of classifiers by using the plurality of learning samples which have been collected;
associating with the data, for each piece of the data included in the data group, a plurality of output values, which are obtained by inputting the data into the plurality of classifiers to identify the data, as an output feature quantity represented in an output feature quantity space different from the feature quantity space; and
classifying each piece of the unknown data included in the data group into any one of a predetermined number of the classes based on the output feature quantity.

6. A program for causing a computer to execute
processing of generating an unknown data pool that contains, among data which is included in a data group and has a feature quantity represented in a feature quantity space, unknown data whose class to be classified into is unknown,
processing of randomly extracting one piece of center data from the unknown data pool, extracting neighborhood data having a feature quantity which is located in a vicinity of a feature quantity of the center data in the feature quantity space, the neighborhood data being extracted in an ascending order of a distance of the feature quantity of the neighborhood data from the feature quantity of the center data in the feature quantity space until a number of pieces of the neighborhood data becomes a predetermined number, and collecting a plurality of learning samples each containing the center data and the neighborhood data which have been extracted,
processing of generating a plurality of classifiers by using the plurality of learning samples which have been collected,
processing of associating with the data, for each piece of the data included in the data group, a plurality of output values, which are obtained by inputting the data into the plurality of classifiers to identify the data, as an output feature quantity represented in an output feature quantity space different from the feature quantity space, and
processing of classifying each piece of the unknown data included in the data group into any one of a predetermined number of the classes based on the output feature quantity.
